(19) United States
(12) Patent Application Publication
(10) Pub. No.: US 2008/0228614 A1
(43) Pub. Date: Sep. 18, 2008

(54) Consumer-driven system and method for promoting philanthropic giving/lending and social activism based on customer purchases

(75) Inventors: Yaron Ben-Zvi, Brooklyn, NY (US); J. Todd Wesley Smith, Arnold, MD (US); R. Rimmy Malhotra, New York, NY (US)

Correspondence Address: Cheryl F. Cohen;Cheryl F. Cohen, LLC, 2409 Church Road, Cherry Hill, NJ, 08002, US

(73) Assignee: Sherwood Advisors, LLC; d/b/a Gratio Capital, New York, NY (US)

(21) Appl. No.: 12/075,697

(22) Filed: Mar. 12, 2008

Related U.S. Application Data
(60) Provisional application No. 60/906,739, filed on Mar. 13, 2007.

(51) Int. Cl. G06Q 30/00

(52) U.S. Cl. 705/35

(57) ABSTRACT

A consumer-driven system and method for promoting philanthropic giving/lending and social activism based on customer purchases. The system and method optimizes the choices on the part of the Customer in the selection of one or more Funding Options and allocation of Funding Points among one or more selected Funding Options. Feedback information concerning the progress of the funds permits the Customer to evaluate the effectiveness or success of the Funding Option; target feedback content to the Customers that have provided funds via the sponsoring entity; and/or prompt the donor/lendor for additional involvement or action concerning the Funding Option to promote continued engagement on the part of the Customer.

### CROSS-REFERENCE TO RELATED APPLICATIONS

This application claims the benefit of U.S. Provisional Application No. 60/906,739, filed Mar. 13, 2007, herein incorporated by reference in its entirety.

### BACKGROUND OF THE INVENTION

1. Field of the Invention

The present invention generally relates to a system and method for enabling socially responsible or socially conscious consumerism. Specifically, the present inventive system and method is directed to an improved consumer-driven or consumer-centric system and method for promoting philanthropic giving/lending and social activism based on Customer purchases.

2. Description of Related Art

Consumers increasingly find that ethical behavior and morality no longer have to take a back seat to consumption. Enter what is known as “socially responsible” or “socially conscious” consumerism. Socially conscious consumerism can be understood as a broad category that may include everything from consumers considering how their purchases can leave less of an environmental footprint, to how they can use product purchases to aide human needs such as hunger or poverty around the world.

Originally, for-profit businesses integrated practices considered to be “socially responsible” into their normal operations. This allowed these businesses to reach and target the emerging market of ethical consumers. Ben & Jerry's™ was one such company. In the course of normal operations Ben & Jerry's™ sought to support local and organic farmers rather than larger corporate-run farms. This approach, along with a carefully crafted marketing image that communicated an image of social responsibility, led Ben & Jerry's™ to build a loyal customer base. The Ben & Jerry's™ approach fits into that category of socially conscious consumption often called ‘ethical consumerism’. Ethical consumption occurs when consumers actively buy products that are made ethically, or avoid those products (boycott) that are not. Other than the Ben & Jerrys™ example, common examples of ethical consumer products include Fair Trade products such as chocolate or coffee, organic food, or sweat-shop free clothing. Cause-related marketing, by contrast, is a practice whereby companies connect the purchase of their products to a positive or ethical cause.

The Ben & Jerry's™ approach, while linking for-profit activity to social responsibility, had two significant problems. First, it did not provide consumers with choice or control over the way Ben & Jerry's was affecting positive social change. Second, and perhaps more significantly, the approach was not sustainable and the company began losing significant sums of money before it was bought out and much of its socially responsible practices were scaled back.

Currently, for-profit businesses have taken on another approach to social responsibility and reaching the ethical consumer. Rather than focusing entirely on making their operations and activities in providing a product or service socially responsible, these businesses have adopted a new method whereby revenue or profit generated from product purchases are used to find specific non-profit, charitable, and social efforts. This form of socially conscious consumption is often referred to as ‘cause-related marketing.’

Ethos Water is one example of a for-profit entity taking this approach. Ethos Water™ sells bottled water and gives a percentage of its revenues ($0.05 per $1.85 bottle) to clean water projects and causes globally. While this approach does avoid the pitfalls of the earlier Ben & Jerry's™ method, it still has two main setbacks. First, like the Ben & Jerry's™ method, it does not give ethical consumers a choice in how the donated funds are used in furthering a socially responsible agenda. Second, there is little transparency in exactly how the money is used to further this cause in terms of disclosure of the particular projects funded or the progress made by such projects.

The Red program, begun by Rock Star Bono, is another current example of the Ethos Water™ cause marketing approach. In this case the program is extended across a wide range of products and services, from credit cards (such as the American Express Red Card™) to clothing (as in the Gap Red Program™). In each case, the provider commits a percentage of profits or revenue to fighting Aids in Africa. Like the Ethos Water™ program, this approach does not provide consumers choice in how this aid is given. If a consumer is more interested in funding education than Aids programs, they must find a different product and program. Similarly, the program is not transparent in how the specific purchase is aiding the effort. It does not indicate if or how much medication was purchased, in what way it was used, if it had any impact, etc.

Affinity credit cards are another example of this approach. Bank of America™ is just one example of a bank that offers credit cards linked to particular non-profits and foundations, including Habitat for Humanity™ and the Nature Conservancy™.

All the methods for enabling socially conscious consumerism (be they through ethical consumerism or cause-related marketing) thus far have had at the very least four problems:
(1) lack of choice or selection on the part of the consumer of the ethical or social agenda to be funded;
(2) lack of transparency in the amount of revenue or profit that is dedicated to charitable or other social projects;
(3) lack of transparency in the use of the dedicated funds, i.e., exactly how the money is spent and what impact it makes. This lack of transparency is itself based on one of two problems: either the for-profit entity does not disclose how exactly it is using the funds, or else the for-profit entity is content to simply give the funds to a non-profit charity but then this charity does not clearly indicate how it is using these specific donations within its various operations;
(4) lack of continued engagement with the consumer. All these methods treat the consumer as a disinterested party. Once their purchase is made, little effort is made to enable them to become more informed, more involved, or to establish a communication with others that care about the same issues that are important to them.

Although it may have its roots in consumer products, socially conscious consumerism is by no means limited to the this world. The desire to marry profits with positive social change has long been part of the investing space thanks to Socially Responsible Investing (SRI), an investment category that has grown impressively to nearly $2.3 trillion in assets under management as of 2005. SRI has been the target of much criticism arising from normative claims that SRI is either ineffective or hypocritical, or based on positivist claims that SRI tends to under-perform other investment types. For the purpose of understanding how SRI fits into the examination of prior methods for enabling ethical consumerism, SRI is much like the Ben & Jerry's™ example. SRI funds seek to make social responsibility agendas part of their operations, in this case by only investing in companies that meet the funds social or ethical criteria (much in the same way Ben & Jerry's™ only did business with dairy farmers that fit their criteria). The problem with this approach is akin to the problem Ben & Jerry's™ experienced. This approach can be a drag on fund or company performance and, as a result, can lead to long-term problems for the entities taking this approach. As Fortune™ magazine points out, the average SRI fund taking this approach has lagged the broad market for the last 3 years. Additionally, SRI suffers from many of the other problems already pointed out including lack of real choice given to the investor in which social causes are pursued and lack of transparency.

Currently, Working Assets™ is a for-profit entity that provides long-distance and cellular telephone service and sets aside 1% of all revenues generated for charitable giving. The company allows their customers to ‘vote’ on how these funds should be distributed. Working Assets™ customers can vote online or via mail from a menu of foundations and organizations that they would like to see the money go to. Clearly Working Assets™ participants or customers are subject to the majority and not able to direct funds generated by proceeds from their own incurred telephone services to a specific charity or foundation that deviates from that majority opinion.

Another example is the online search engine GoodSearch™ that donates a portion of its revenue to non-profits. When using the search engine, individuals can select a specific non-profit that they would like the proceeds from their searches to go to. Additionally, GoodSearch™ has addressed some aspect of the transparency problem. GoodSearch™ users are able to see exactly the dollar amount that has been donated to their non-profit of choice. Still, a number of the problems pointed out above remain. There is still a lack of transparency in terms of how each foundation is using the funds raised and there is no continuing engagement of the individual.

Just as for-profit entities such as Working Assets™ and GoodSearch™ have made some progress toward addressing part of the four central problems pointed out here, non-profit entities have also made some progress. As an example, the issue of transparency in the manner in which donated funds are used is being addressed by online micro-credit lending site Kiva.org. Micro-lending is the process whereby individual entrepreneurs in developing areas are loaned small amounts of money for use in building a business that can sustain them and their families for the long term. For example, a fisherman in Africa may need a $300 loan to buy a new fishing net and the funds may be unavailable to him since typically the only credit available is through loan sharks or institutions whose interest rates are exorbitant. As an alternative, an organization may lend the fisherman the $300 at either a very small or at times even zero percent interest rate. The founder of the Grameen Bank, the first organization to institute such a micro-lending program was awarded the 2006 Nobel Peace Prize. Kiva, for their part, is a non-profit entity that sources entrepreneurs from countries all over the world and places their profiles on its site, along with the loan amount needed and the reason for the loan. Online users can then make loans to the specific entrepreneur and fund his or her project. In this way, the philanthropist or lender knows exactly how their funds are being used and what impact is being made.

Global Giving™ is another non-profit entity that sources projects that online users can donate to via the Internet, thereby circumventing the problem of transparency in how funds are used. Unlike Kiva, however, Global Giving™ does not do micro-lending. Their donations are not expected to be repaid and rather than donating to entrepreneurs or individuals, the types of projects funded through Global Giving™ might be the building of a latrine, a school, or some other structure.

Both Global Giving™ and Kiva allow donators or lenders to choose individuals or projects to which they can contribute separate from the non-profit that happens to be funding it.

The online model used by Kiva and Global Giving™ has also enabled these two non-profits to acknowledge the donation or loan.

Heretofore, the sponsoring entity merely posted a thank you message from the individuals that received the loans. Neither model allows the sponsoring entity to provide information concerning the project and its progress in such a way that is specifically tailored to the audience that is doing the funding through these vendors and/or the feedback information provided does not allow the donor/lendor to simultaneously evaluate the effectiveness and progress of the funds donated/lent.

It would therefore be desirable to develop a feedback system that addresses the following considerations: (i) provide feedback that permits the donor/lendor to evaluate the effectiveness or success of the particular project in order to universalize the feedback from those sponsoring or executing entities; (ii) target feedback content to the specific donors that have provided funds via the sponsoring entity, as opposed to any donor to the project or organization in question; and/or (iii) prompt the donor/lendor for additional involvement or action concerning the topic or cause related to the project being funded.

Heretofore, for-profit models have not integrated transparency of fund use by providing the aspect of consumer choice and transparency feedback to the donors as to how the funds are used while connecting these advantages and advancements to product consumption and by extension to socially conscious consumerism.

It is therefore desirable to develop an improved consumer-driven or consumer-centric system and method linked to socially conscious consumerism in a way heretofore not previously explored wherein the Customer is provided with optimum autonomy on the one hand in the initial allocation of the funds and on the other hand continued engagement concerning the progress of such funding subsequent to its disbursement to promote future participation.

### SUMMARY OF THE INVENTION

Accordingly, several objects and advantages of the present invention are:
(a) to provide a system and method for enabling socially conscious consumerism that addresses the problems and deficiencies in the prior and current art.
(b) to provide a system and method for linking purchases to charitable and philanthropic giving or lending in a way that addresses the problems and deficiencies in the prior art.
(c) to provide a system and method for providing choice in the manner in which social responsibility is pursued once a purchase with social benefits has been made.
(d) to provide a system and method of product consumption that will increase the amount of funds donated to charitable foundations, organizations and projects.
(e) to provide a system and method for linking charitable giving or lending to purchases that encourages other for-profit entities to adopt socially conscious consumption systems and methods.
(f) to provide a system and method for socially conscious consumerism that is transparent to the consumer in terms of how the funds are used to further social responsibility agendas.
(g) to provide a system and method for socially conscious consumerism that is transparent to the consumer in terms of the type projects funded (organization/foundation-level, project-level, individual-level) and the impact of projects funded via socially responsible initiatives.
(h) to provide a method for socially conscious consumerism that provides feedback on the progress of funds provided or initiatives undertaken.
(i) to provide a system and method for socially conscious consumerism that seeks to engage the consumer beyond the initial donation or loan.

Further objects and advantages will become apparent from a consideration of the ensuing description and drawings.

In accordance with the present invention the system and method of socially conscious consumption involves a Customer purchasing an item from a Vendor. A portion of the financial benefit generated by the purchase being dedicated by way of a donation or loan to charitable and philanthropic giving or lending; the Vendor from which the purchase was made providing the Customer that made the purchase a plurality of projects, organizations, or causes to which the donation or loan may be allocated or the Customer specifying an organization to which the donation or loan may be allocated not initially provided by the Vendor; a choice or selection being made by the Customer as to one or more projects, organizations or causes to fund; the actual funding of the project, organization or cause by the Vendor; and feedback whereby the Vendor provides information updates to the Customer about the project or cause funded.

The consumer-driven system and method in accordance with the present invention promotes philanthropic giving/lending and social activism based on customer purchases. The system and method optimizes the choices on the part of the Customer in the selection of one or more Funding Options and allocation of Funding Points among one or more selected Funding Options. Feedback information concerning the progress of the funds permits the Customer to evaluate the effectiveness or success of the Funding Option or to deepen Customer engagement with the giving process; target feedback content to the Customer that have provided funds via the sponsoring entity; and/or prompt the donor/lendor for additional involvement or action concerning the Funding Option to promote continued engagement on the part of the Customer.

A first aspect of the present invention relates to a method for operating a consumer-driven system for promoting philanthropic giving/lending and social activism based on a Customer purchase from a Vendor. Funding points are issued to the Customer based on the purchase from the Vendor. Then, the Customer's autonomous selection is received of at least one Funding Option from those provided in a Funding Options Pool including one or more Funding Options. In addition, the selected Funding Option, the Customer's autonomous allocation of issued Funding Points to the selected at least one Funding Option is also received. Lastly, the selected at least one Funding Option is funded based on the Customer's allocation of issued Funding Points.

Another aspect of the invention is directed to a method for operating a consumer-driven system for promoting philanthropic giving/lending and social activism based on a Customer purchase from a Vendor. Initially, Funding Points are issued by the Vendor to the Customer based on the purchase from the Vendor. In turn, the Customer selects at least one Funding Option from those provided in a Funding Options Pool including one or more Funding Options, each Funding Option being classified as either a gift or a loan, wherein the gift or loan is on one of a cause-level, organization/foundation-level, project-level or individual-level. The Customer may also add to the Funding Options Pool if he or she would like to allocate Funding Points to an organization not already included in the Funding Options Pool. The Customer also allocates its issued Funding Points to the selected at least one Funding Option by either making a one-time allocation or by setting allocation preferences which are then used to automate future Funding Point allocations. Funding of the selected at least one Funding Option is then realized based on the Customer's allocation of issued Funding Points. Finally, feedback information is received concerning the funding provided to the at least one selected Funding Option and accessed by the Customer.

Still another aspect of the present invention is directed to a computer implemented method for operating a consumer-driven system for promoting philanthropic giving/lending and social activism based on a Customer purchase from a Vendor. Funding Points are issued to the Customer using a computer system, the Funding Points being issued are based on the purchase from the Vendor. The Customer's autonomous selection of at least one Funding Option from those provided in a Funding Options Pool including one or more Funding Options or from those added to the Option Pool by the Customer is received. In addition, the Customer's autonomous allocation of issued Funding Points to the selected at least one Funding Option is also received based on an allocation that was made either on a one-time basis or based on allocation preferences set by the Customer that apply to future or ongoing Funding Options. Lastly, the selected at least one Funding Option is funded based on the Customer's allocation of issued Funding Points retrieved from the computer memory.

Yet another aspect of the present invention is directed to a computer program embodied on a computer-readable medium for operating a consumer-driven system for promoting philanthropic giving/lending and social activism based on a Customer purchase from a Vendor. The computer program includes: (a) a code segment that issues Funding Points to the Customer, the Funding Points being issued are based on the purchase from the Vendor; (b) a code segment that receives the Customer's autonomous selection of at least one Funding Option from those provided in or added to a Funding Options Pool including one or more Funding Options; (c) a code segment that receives the Customer's autonomous one-time allocation or ongoing allocation preferences of issued Funding Points to the selected at least one Funding Option; and (d) a code segment that funds the selected at least one Funding Option based on the Customer's allocation of issued Funding Points.

### BRIEF DESCRIPTION OF THE DRAWING

The foregoing and other features of the present invention will be more readily apparent from the following detailed description and drawings of illustrative embodiments of the invention wherein like reference numbers refer to similar elements throughout the several views and in which:

FIG. 1A is an exemplary flow chart of a method for promoting socially conscious consumerism in accordance with the present invention;

FIG. 1B is an exemplary high level schematic diagram of a system for promoting socially conscious consumerism in accordance with the present invention;

FIG. 2 is an exemplary block diagram illustrating the Customer's control over those projects and causes to be funded in accordance with the present invention;

FIG. 3 is an exemplary flow chart of conversion schemes utilized in converting the monetary value of a purchase by the Customer to Funding Points;

FIG. 4 is an exemplary flow chart depicting the sourcing of available projects or causes for funding;

FIG. 5 is an exemplary flow chart depicting Customer-driven selection of Funding Options of interest;

FIG. 6 is an exemplary flow chart of possible communication methods to be used by the Customer for choosing Funding Options and allocating funds to those selected projects and causes;

FIG. 7 is an exemplary flow chart of the funding of selected projects and causes by the Vendor based on the allocation of Funding Points by the Customer;

FIG. 8A is schematic block diagram for a specific embodiment of the present invention showing the interaction between an Individual Investor and Advisor when the purchase is a financial investment in a mutual fund; and

FIG. 8B is a flow chart for a specific embodiment of the funding of a project or cause based on the purchase of a financial investment of $10,000 in a mutual fund by an Individual Investor from an Advisor.

### DETAILED DESCRIPTION OF THE PRESENTLY PREFERRED EMBODIMENTS OF THE INVENTION

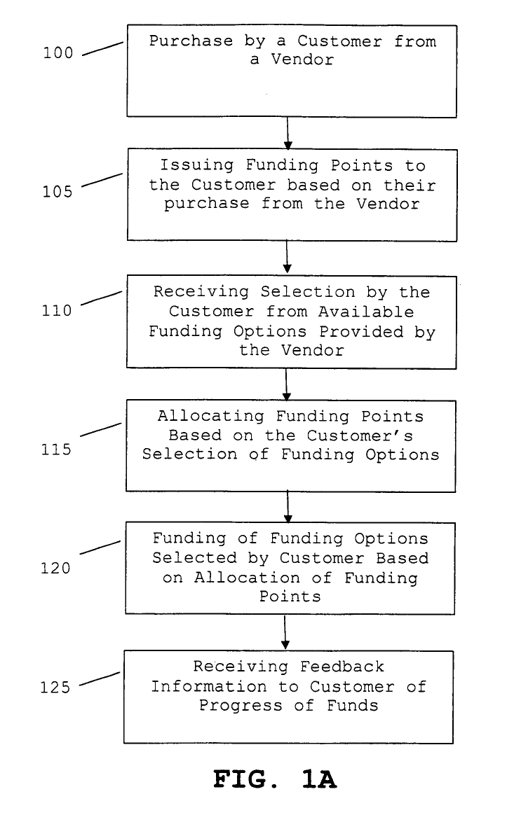

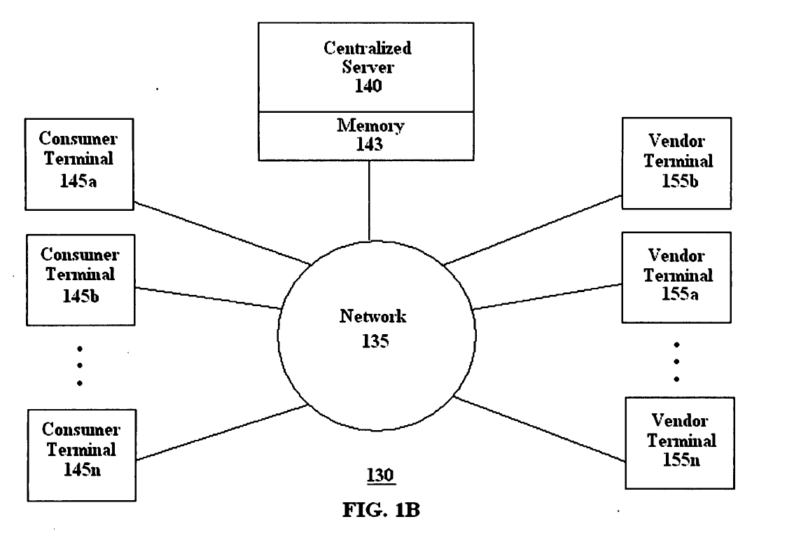

The present invention is directed to a consumer-driven or consumer-centric system and method for linking a Customer purchase (e.g., item, product, service, article and/or goods, whether tangible or intangible) from a Vendor with philanthropic giving/lending and social activism. FIG. 1A is a flow chart of a broad overview of the method for linking product purchases with philanthropic giving/lending and social activism in accordance with the present invention.

In step 100, a purchase is made by a Customer from a Vendor. Either simultaneously with or subsequent to the purchase, in step 105 the Customer is issued Funding Credits or Funding Points. The quantity, amount and value of Funding Points are determined by the Vendor simultaneously with or subsequent to the purchase. Funding Points are directed or allocated toward one or more Funding Options selected by the Customer from those available Funding Options the Vendor has either sourced on its own, acquired from third party sources or perhaps been identified and added by the Customer themselves. The Vendor provides the Customer with a plurality of available social and/or charitable Funding Options (e.g., Organization/Foundation-level Funding Options, Cause-level Funding Options, Project-level Funding Options, and/or Individual-level Funding Options) from which to choose in order to direct, route or allocate their issued Funding Points based on their purchase. The Customer may choose to allocate all their Funding Points to a single Funding Option or to divide the Funding Points among multiple Funding Options. The Customer may further allocate Funding Points on a one-time basis or may set allocation preferences to be used on an ongoing basis for future Funding Points. In step 110, the Customer makes a selection of one or more Funding Options from among the available Funding Options provided by the Vendor. Subsequently, in step 115 the Funding Points are allocated to the respective Funding Option(s) based on the Customer's selection. Following the allocation of Funding Points by the Customer, appropriate funding is thereafter distributed to the selected Funding Option(s) in step 120. Thereafter, in step 125, tracking, monitoring or other feedback information is provided to the Customer associated with each of their one or more selected Funding Options concerning the progress of the funding. Such information allows the Customer to remain actively engaged following the relinquishing of the initial funds by tracking the impact of their investments and creating a platform for initiating additional activism and involvement.

An exemplary high level schematic diagram of a system for carrying out the method set forth in FIG. 1A is shown in FIG. 1B. The system 130 depicts a configuration in which participants communicate via a network 135 for exchanging information/data or transacting business such as the Internet, an intranet, an extranet, Ethernet, ATM, wide area network (WAN), local area network (LAN), Public Switched Telephone Network (PSTN) or satellite communications. Hereinafter the present invention will be shown and described with respect to the Internet, however, other networks are contemplated and within the intended scope of the present invention. The participants (e.g., Customers and Vendors) may interact in the system via terminals or computing devices (Customer Terminal 145, Vendor Terminal 155) such as a personal computer, network computing devices, workstation, laptop, minicomputer, mainframe, kiosk, personal digital assistant (PDA), handheld or mobile computer (e.g., Palm Pilot®), mobile telephone and/or any combination thereof which may be either wired or wirelessly connected to the network 135. One or more Vendors offer available products and/or services to the Customer. In the illustrated example shown in FIG. 1B, the Vendors are represented by respective Vendor Terminals (155a, 155b, . . . 155n) by which available products and/or services are offered to Customers via the Internet, however, any means of communication may be employed. For example, in addition to or aside from the Internet, the items may be offered via a printed catalog, stores, or over the telephone. By way of illustrative example only, FIG. 1B depicts a single terminal associated with each Vendor, however, a single Vendor may use multiple terminals or multiple Vendors may share a common terminal. Similarly, Customer Terminals 145a, 145b, . . . 145n may each be used by a single Customer or shared among multiple Customers to make their purchases of items being offered by the Vendors via the Internet 135. The network may be used to connect any number of one or more Customer Terminals 145 with one or more Vendor Terminals 155. Customer Terminals 145a, 145b, . . . 145 and Vendor Terminals 155a, 155b, . . . 155n have stored therein the appropriate software necessary to communicate via the Internet as well as to store any necessary information.

A centralized or main server 140 monitors or tracks the participating Vendors and purchases made by Customers from participating Vendors. This information is stored in a memory 143 associated with the centralized or main server 140 along with a conversion or allocation scheme or algorithm as to how each participating Vendor calculates Funding Points based on the Customer purchases. In turn, centralized or main server 140 either directly or via the respective Vendor issues Funding Points to the Customer based on their purchases and the Funding Point calculations.

Participating Vendors provide a plurality of Funding Options (e.g., organization/foundation-level options, cause-level options, project-level options, and/or individual-level options) collectively referred to as a Funding Option Pool from which the Customer may choose. The Vendors may post these available options via the Internet on their website; however, alternative methods may be provided for communicating these options to the Customers. Users, in turn, navigate to the Vendor's website and select one or more from the available Funding Options to which to direct, allocate or route their issued Funding Points. The Funding Options Pool may be sourced by: (i) the Vendor; (ii) third party sources; and/or (iii) specified by the Customer themselves if the organization is not currently identified in the Funding Options Pool and qualifies as a non-profit organization under section 501(c)(3). By way of example, a Customer interested in allocating Funding Points to the Red Cross™ can add this organization to the Funding Options Pool. In the case in which the Customer selects as the Funding Option a particular project or organization the Funding Points will be distributed to that specific project or organization based on the Customer's specified allocation. For instance, the Customer may designate that Habitat for Humanity™ receive all of the issued Funding Points. Alternatively, the Customer is also provided with the option of selecting a cause as the Funding Option, rather than a particular project or organization. In specifying a cause the final entity to receive the Funding Points has not clearly been defined as in the case of allocating to a particular project or organization. Instead, the Vendor may ultimately use the Customer Funding Points to fund any organization, project or entity that supports the cause allocation chosen. In addition, the timing and type of feedback information that the Customer receives when specifying a cause as the Funding Option, in turn, may or may not be different than in the case in which the Customer specifies a particular project and/or organization as the Funding Option. Thus far, what has been described is a one time selection of a particular project, organization or cause. However, it is also possible to specify a particular project, organization or cause as the Funding Option preference on a repeated and ongoing bases. That is, using the Customer specified project, organization or cause Funding Option preference the Vendor may automatically use future purchases and accumulated Funding Points for funding based on this cause preference, unless and until directed otherwise.

Centralized or main server 140 either directly or via the respective participating Vendor distributes the issued Funding Points based on the one or more Funding Options selected by the Customer. Following the transfer or distribution of funds to the selected Funding Options, the entities (charities, foundations, organizations, or individuals) associated with these options provide via the Internet or some other communication method feedback information concerning the progress or status of those funds that may be accessed by the Customer. This feedback information may be sent directly to the Customer, for instance, by way of e-mail messages. Alternatively, the feedback information may be posted at a common site accessible by anyone or only those Customers that have selected that particular Funding Option.

It is desirable to provide a feedback system that permits the donor/lendor to evaluate the effectiveness or success of the particular project (based on such factors as: (i) how the funds have been put to use, (ii) the number of people assisted by the funding, (iii) duration of estimate effect, and (iv) percentage of project complete) in order to universalize the feedback from those sponsoring or executing entities. Furthermore, the content of the feedback information in accordance with the present invention is preferably accessible by those Customers that have provided funds via the sponsoring entity, as opposed to any donor to the cause, project or organization in question. Lastly, the feedback information is preferably designed to prompt the donor/lendor for additional involvement or action concerning the topic or cause related to the project being funded.

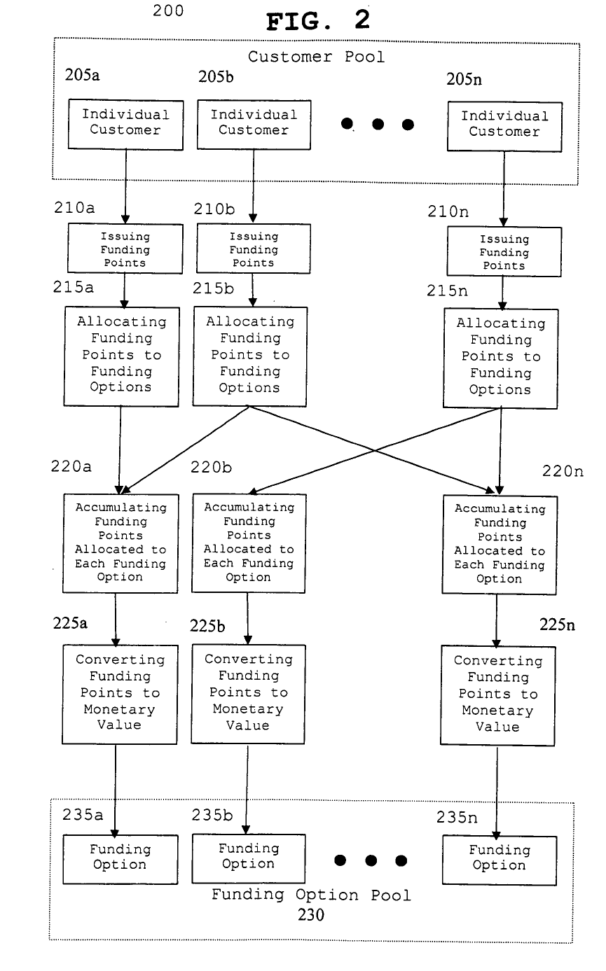

Each Customer independently selects one or more Funding Options to which to direct, allocate, or route their own issued Funding Points. Collectively all participating Customers are hereinafter referred to as a Customer Pool, while the various Funding Options (organization/foundation-level options, cause-level options, project-level options, and/or individual-level options) provided by all of the participating entities (individuals, companies, organizations, charities, or foundations) are collectively referred to as a Funding Options Pool. FIG. 2 provides an exemplary diagram illustrating the Customer's control over funding in accordance with the present invention. Transfer of Funding Points from individual Customers 205a, 205b, . . . 205n in a Customer Pool 200 to fund Funding Options (e.g., organization/foundation-level options, cause-level options, project-level options or individual-level options) 235a, 235b, . . . 235n comprising a Funding Options Pool 230 is under each individual Customer's independent control. The Funding Options Pool 230 represents all the available levels of options requiring funding that the Vendor has sourced itself, acquired from third parties or been specified by the Customer themselves. As previously mentioned above, the Vendor issues Funding Points to participating Customers based on purchases made from that Vendor. In blocks 210a, 201b, . . . 210n Vendors issue participating Customers Funding Points based on their purchases from that Vendor or a third party associated with that Vendor. Blocks 215a, 215b, . . . 215n depict each Customer's individual preference allocation of their issued Funding Points to one or more selected Funding Options independent of any other Customer's selection or allocation. True choice is therefore enabled in the Customer's pursuit of socially conscious consumerism at various levels (organization/foundation-level, cause level, project level, and/or individual level). In the example shown in FIG. 2, several exemplary allocations are depicted. Customer 205a is shown allocating their issued Funding Points to a single Funding Option 235a. Whereas, Customers 205b and 205n allocate their Funding Points among multiple Funding Options. Specifically, Customer 205b allocates their issued Funding Points to Funding Options 235a, 235n, whereas Customer 205n distributes their issued Funding Points among Funding Options 235b, 235n. It is contemplated and within the intended scope of the present invention for each Customer to allocate their issued Funding Points to any number of one or more Funding Options, as desired. Not only are the Customers in control of the selection of which one or more Funding Options to which to direct their funds but in addition, the Customer designates how the issued Funding Points are to be divided among multiple Funding Options. On the one hand, the Funding Points may be distributed to the respective Funding Option(s) selected by the Customer based on a one time specified allocation. In the case in which the Customer has selected a Funding Option preference, the accumulated Funding Points may be distributed based on a one time specified allocation or on an ongoing allocation preference unless and until directed otherwise. For example, the Customer can direct an allocation preference of 50% of all accumulated Funding Points be distributed on a quarterly basis to the Salvation Army™ as a preferred Funding Option on an ongoing basis, unless and until directed otherwise.

Blocks 220a, 220b, . . . 220n depict accumulating a total of distributed or allocated Funding Points maintained on behalf of each associated Funding Option 235a, 235b, . . . 235n in the Funding Option Pool 230 as individual Customers allocate their Funding Points. A conversion of accumulated Funding Points to an equivalent monetary value or amount to be allocated to corresponding Funding Options is represented by blocks 225a, 225b, . . . 225n. This conversion is based on a relationship as established by each participating Vendor and may differ for each Funding Option. The monetary finds are then appropriately distributed to the respective Funding Options 235a, 235b, . . . 235n.

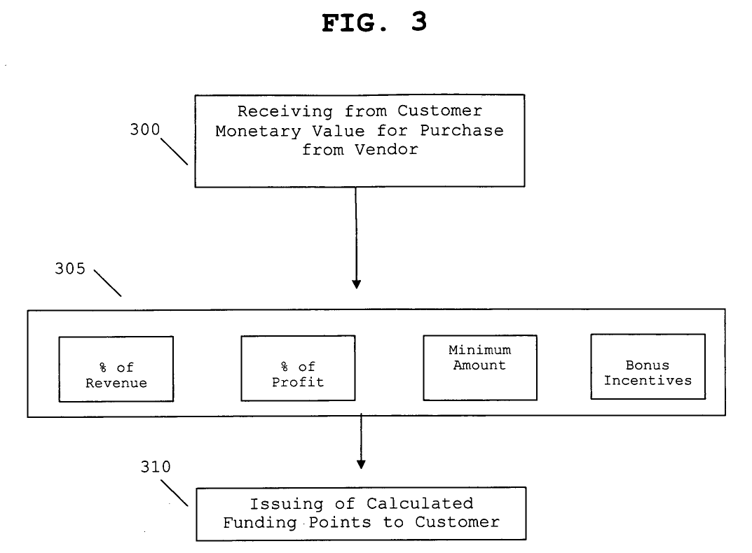

FIG. 3 depicts a diagram of the calculation of Funding Points by a Vendor for a purchase made by a Customer. In block 300, a purchase having an associated monetary value is initiated by a Customer for an item offered by a participating Vendor. Each participating Vendor independently establishes a function or scheme for converting or calculating Funding Points. A single conversion or calculation scheme may be applied by a participating Vendor for all possible purchases. Alternatively, different conversion or calculation schemes may be used by a participating Vendor based on such factors as the monetary value of the purchase, the product or service being purchased, or any other factors. Some preferred and most likely used conversion schemes take into consideration such variables including, but not limited to: a percentage of the monetary value or revenue from the purchase, a percentage of the profit on the purchase, and/or some predetermined fixed minimum amount of Funding Points. Yet another variable that may be used to tabulate the Funding Points is the issuance of bonus or incentive points offered by a Vendor based on certain purchases or matching point programs that might be included with financial instruments such as 401k plans, or any other incentives. The conversion or calculation may occur manually and/or via software residing at the Centralized Server 140, the individual Customer Terminals 145a, 145b, . . . 145n, the individual Vendor Terminals 155a, 155b . . . 155n, or a combination thereof. Such conversion software may include any one or more of the variables mentioned herein as well as other factors not enumerated.

Ultimately, based on the conversion function employed by the Vendor, Funding Points are calculated and issued to the specific Customer in blocks 305 and 310, respectively. Distribution of Funding Points can occur, as desired by the Vendor, adopting a variety of systematic methods or times. For example, a Customer account, rewards card, affinity card, or other recording method may be automatically credited with the appropriate Funding Points at the time of purchase. Alternatively, distribution may occur subsequent to the purchase. Online or offline software may be used for Funding Point tracking and distribution.

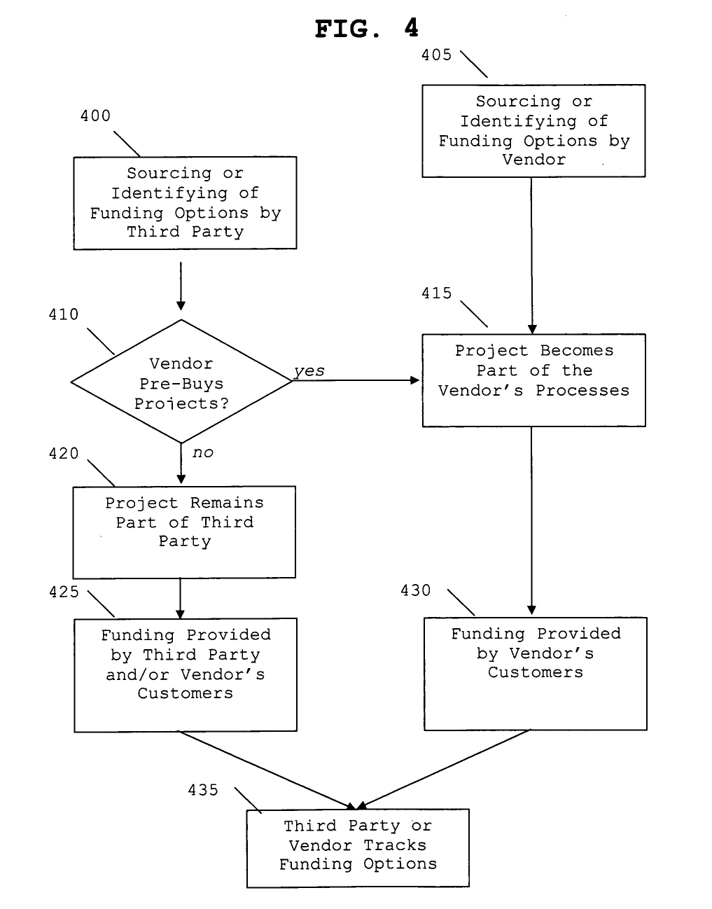

FIG. 4 is an exemplary flowchart describing sourcing of available Funding Options for selection by the Customer in accordance with the present invention. Two possible sources for identifying available Funding Options are presented in FIG. 4. Funding Options may be sourced by a third party (as depicted in step 400), by a participating Vendor (as depicted in step 405) that itself identifies opportunities to fund specific individuals, causes, projects or social/charitable causes requiring funding, or else Funding Options may be designated by Customers seeking to allocate Funding Points such as to specific eligible non-profit organizations, as described previously. Depending on how the initial identification occurs, the Funding Option may either become part of the funding process or may be controlled by the third party or the Vendor.

As depicted by the right hand side of the flow chart in FIG. 4, those Funding Options identified by the Vendor independent of a third party remain with the Vendor and become part of its regular funding process, meaning the Vendor's Customers are able to allocate funds (via Funding Points) to Vendor identified Funding Options using procedures controlled and implemented by the Vendor. In such circumstances, the Vendor is most likely responsible for following up on and providing feedback to the Customer about the progress of funds made to the Funding Option.

If, however, the Funding Option is identified by a third party (as depicted by the left hand side of the flow chart in FIG. 4), the Vendor may nevertheless be presented with an option of ‘pre-buying’ the Funding Option (decision block 410) by outlaying the funds in advance of the allocation of Funding Points by Customers. Pre-bought Funding Options become part of the Vendor's funding process and infrastructure and are presented to Vendor's Customers for potential Funding Point allocation, as depicted by blocks 415 and 430. In this way, the Vendor essentially buys and thus funds ahead of time an inventory of social impact Funding Options.

In the event that the Vendor chooses not to exercise or is not presented with an option to pre-buy a Funding Option sourced by a third party then the Funding Options will remain part of the third party's normal funding processes (block 420). Under such circumstances, the third party sourced Funding Option may receive funding from the third party as well as from Vendor Customers but the funding processes occurs using procedures controlled and implemented by the third party. The third party typically remains responsible for tracking and providing feedback information to Customers on the progress of the funds sourced by the third party. In any case, irrespective of how the Funding Option is sourced, either party (the Vendor or the third party) may track the funds after being distributed to a particular Funding Option, as depicted by block 430. Software may be used to perform such functions as tracking or managing of the commercial transactions between the Customer and Vendor, the available Funding Options identified by each participating Vendor as well as the funding status of each, and the feedback and progress reports. This software may reside at the Centralized Server 140, the individual. Customer Terminals 145a, 145b, . . . 145n, the individual Vendor Terminals 155a, 155b . . . 155n, or a combination thereof. Additionally, multiple servers may be employed in lieu of the Centralized Server 140.

Many different types and levels of options may be funded in accordance with the system and method of the present invention. Specifically, the arrangement may be either a gift/donation (not to be repaid) or a loan (to be repaid, possibly with interest). These categories of arrangements may be further subdivided depending on whether the arrangement is made on an individual-level, a cause-level, a project level, or an organization/foundation-level. Some possible arrangements include, for example:
(1) Project-level giving: Customers give money away at the project level. This may include things such as funding a school, planting a tree, etc.
(2) Project-level lending: Customers can choose specific projects for micro-lending to be repaid (as opposed to a donation, gift or charity). In this category, the money funded is paid back and, as a result, Customers receive Funding Points back for reallocation once the loan has been re-paid.
(3) Cause-level giving: Customers give money away at the cause level. This may include things such as funding a education and children; environment and animals, etc.
(4) Cause-level lending: Customers can choose specific causes for micro-lending to be repaid (as opposed to a donation, gift or charity). In this category, the money funded is paid back and, as a result, Customers receive Funding Points back for reallocation once the loan has been re-paid.
(5) Individual-level giving: Customers give to fellowships to fund specific individuals doing work in areas they care about. In this category, giving happens for specific people that effectuate social change rather than specific projects.
(6) Individual-level lending: Customers can choose specific individuals for micro-lending to be repaid (as opposed to a donation, gift or charity). In this category, the money funded is paid back and, as a result, Customers receive Funding Points back for reallocation once the loan has been re-paid.
(7) Foundation/Organization-level giving. Customers give money away at a foundation or organization level (Red Cross, Sierra Club, etc). This is the most traditional kind of giving. The giving in this category is to the foundation or organization itself rather than at a cause or project level.

These are but a few examples of the types of arrangements that may be offered as Funding Options in the Funding Options Pool available for selection by the Customer. To provide a more user friendly and efficient selection on the part of the Customers when the Funding Options Pool has a significant number of entries, the Funding Options available in the Funding Options Pool may be narrowed or restricted by the Customer by one or more factors such as, but not limited to, (i) geography of the cause or project to be funded; (ii) subject matter, topic or category of cause or project to be funded (e.g., education, hunger, housing, healthcare, etc.); (iii) lending versus donation; (iv) level of cause or project to be funded (e.g., organization/foundation-level; project-level; individual-level); (v) the amount of Funding Points or dollars in total needed to fund a project or option; (vi) the amount of Funding Points or dollars required until a project or option is fully funded (vii) an organization or sponsor name.

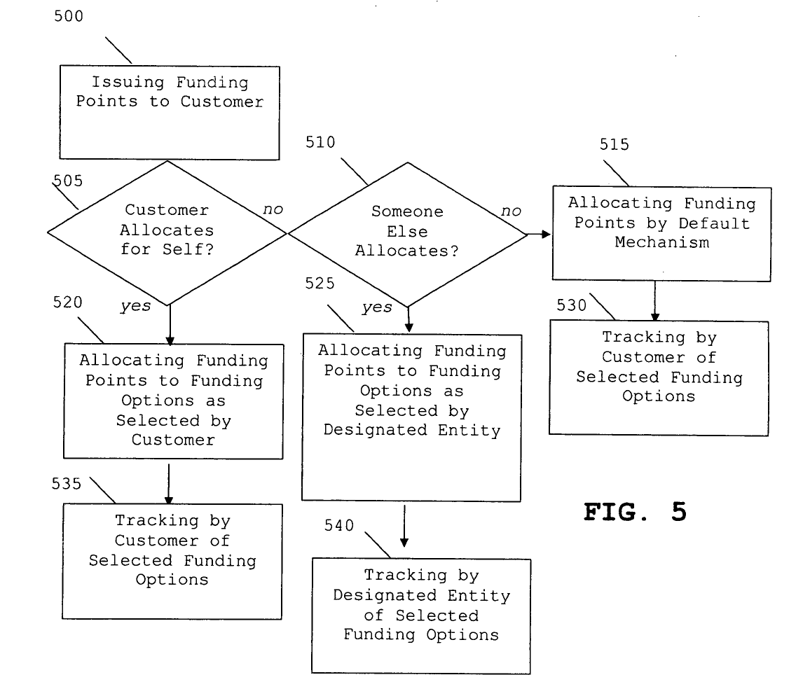

As previously mentioned, the present inventive system is Customer-driven or Customer-centric in that the Customer is provided autonomy in selecting one or more Funding Options. A more detailed explanation will now be provided as to the specific features associated with the Customer-driven selection process. Referring to the exemplary flow chart in FIG. 5, Funding Points are issued to the Customer in step 500 based on their purchase from a Vendor. A decision is presented in decision blocks 505, 510 whom to designate the authority for selecting the Funding Options to which to allocate the issued Funding Points. Three possible scenarios or choices are presented to the Customer. In a first scenario, the Customer may designate their self to retain complete autonomy in the selection of Funding Options to be funded. In such a case, the Customer themselves makes the selection as to the one or more Funding Options to which to allocate their funds from a list or menu of available Funding Options provided by the Vendor. Thereafter, in steps 520, 535 the Customer allocates their own issued Funding Points to the selected one or more Funding Options based on their own preferences and tracks the progress of these funds. As previously noted, such allocation may occur on a one-time basis or else the Customer may designate allocation preferences to be used for current and future earned Funding Points.

However, a Customer may choose not to retain control themselves over the allocation of their own issued Funding Points. If a Customer lacks the time or knowledge to determine how to allocate their issued Funding Points they can designate another entity to do the allocation for them. A second scenario has the Customer (Designator) designate by way of proxy their authority to another entity (hereinafter referred to as a Designated Entity or Proxy Entity) to select the Funding Options to which their funds are to be allocated on the Customer's behalf. The Designated Entity may be an individual (such as another participating Customer, an individual who is not a participating Customer, a community member, or company representative), a corporation, a foundation, an organization, or any other entity. Such individuals may be considered ‘experts’ on certain causes or areas of social responsibility or may otherwise be desirable for allocating Funding Points. To provide useful information in the Customer's selection of a Designated Entity, individuals may be rated by participating Customers via an online tool for how well they know certain topics and how well they have acted in their allocation of Funding Points via proxy. The rating system may be designed, as desired, to include such factors as: (i) the overall rating issued based on a point system given by participating Customers based on their own subjective evaluation; (ii) the number of Customers that have participated in the rating system; (iii) the number of Funding Points allocated thus far to the individual to be rated; (iv) the number of reviews/ratings issued by Customers of previously funded projects or causes; and/or (v) frequency of participation or use of Funding Points by the individual that is to be rated. Other factors that may be used as supportive data to help Customers evaluate community members might be related professional designations of the individual to be rated (for example, a teacher or professor may have unique qualifications or expertise with respect to an educational funding option) or qualitative assessments of the individual to be rated by other Customers. In each case, online software would most likely be used to accomplish the rating systems, though other methods might also be explored.

This Designated Entity may be selected by the Customer (Designator) from a predetermined list of available Designated Entities (e.g., other participating Customers) or merely identified by the Customer (Designator) providing appropriate contact information to establish communication (e.g., providing the e-mail address of the Designated Entity). Once chosen by the Customer (Designator), thereafter the Designated Entity chooses the Funding Options, allocates the Customer's (Designator's) issued Funding Points based on their selection of Funding Options and tracks the progress of those funds, as indicated by steps 525 and 540.

The last scenario is one in which the Customer either affirmatively selects a default allocation scheme or fails to affirmatively assert either themselves or a Designated Entity as the authority for making the selection of one or more Funding Options to which to direct their issued Funding Points. In either case a default allocation algorithm or scheme is applied. The Vendor may design this default allocation scheme as desired. One exemplary default allocation scheme may be a pro-rata allocation of that particular Customer's Funding Points based on the total allocation of all other participating Customers Funding Points. In this way, the default allocation scheme mirrors the overall Customer community's preferences. An alternative default allocation scheme may permit Customers to mimic a particular celebrity's method for allocation. So, for example, if Angelina Jolie posted her ideal or personal allocation based on the causes she is most interested in and engaged with, Customers would be able to allocate their Funding Points based on Ms. Jolie's preferences. Since the Customer's time is limited, such celebrity preferences may be readily provided by a predefined list or menu of most common celebrities and their causes.

Once the Customer has been issued Funding Points as a result of their purchase any number of one or more communication methods may be employed to allocate the Funding Points to Funding Options chosen by the Customer. The number of online Internet transactions and purchases is dramatically increasing every year. It would therefore be very convenient for the Company to take advantage of the Internet for posting information online concerning the list or menu of available Funding Options from which the Customer may select. Another advantage associated with the Internet is that the initial purchase may be made from the same website that also displays the list of available Funding Options thereby providing the most convenience to the Customer.

Other means of communication may be used instead of or in combination with the Internet, such as, but not limited to, printed media or the telephone. Thus, the process may be established so that any stage: initial purchase, selection of Funding Options, or Allocation of issued Funding Points to the selected Funding Options may be realized by a single method of communication or multiple methods of communication.

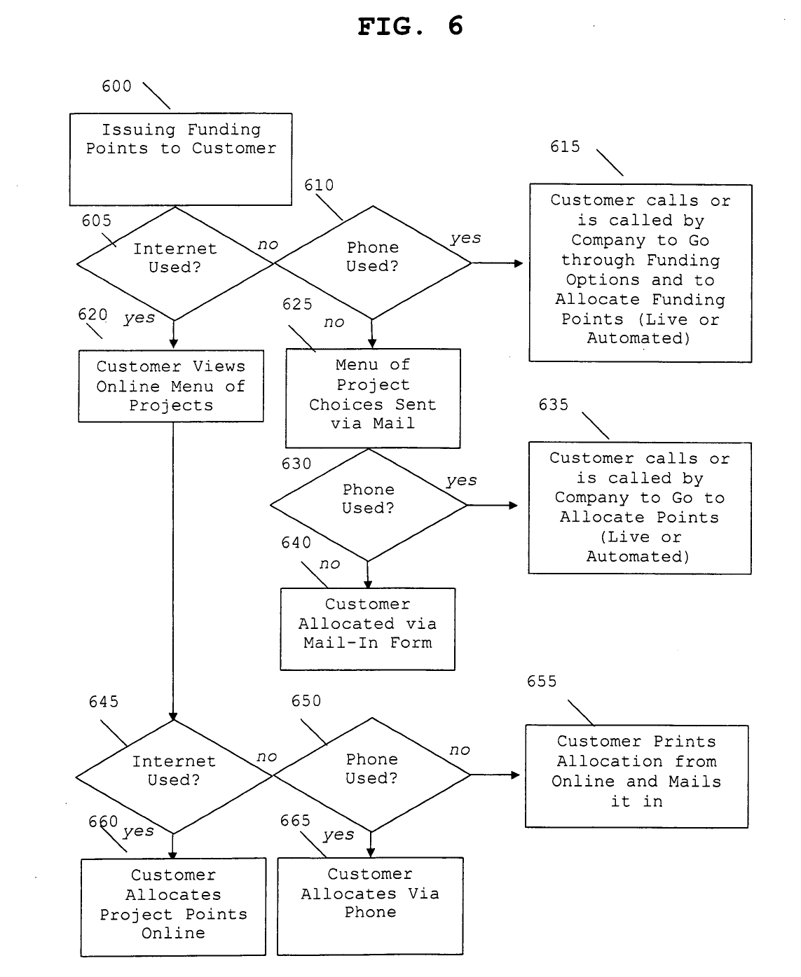

FIG. 6 is an exemplary diagram depicting Funding Point allocation in accordance with the present invention that provides the Customer with one of three different types of methods of communication: via the Internet, the telephone, or hardcopy printed media. In block 600 the Customer is issued Funding Points based on their purchase from the Vendor. Decision blocks 605, 610 provide the Customer with the option of reviewing the list of available Funding Options in one of three ways: via a menu or list posted on the Internet, via the telephone or by printed matter (sent by mail or faxed). If the Customer views the list or menu of available Funding Objects online (block 620), the Customer is provided with several communications method options, via decision blocks 645, 650, as to how to allocate the issued Funding Points among the selected Funding Options. Allocation may be established online, as represented by block 660, where the Customer both views and allocates Funding Points to the Funding Options via a single website. Otherwise, as represented by block 665, allocation can occur over the phone whereby a Customer calls the Vendor or vice versa. This use of the phone may be automated, whereby the Customer selects a button online and is automatically called for point allocation or, alternatively, whereby the Customer's online point allocation is translated into a series of numbers that are inputted into the phone for automated processing. Alternatively, Funding Point allocation may occur without online or phone use if the Customer fills out and mails a point allocation form from the website where the Funding Options are posted (see block 655).

In an instance where the Internet is not used to provide a list or menu of available Funding Options to the Customer, the Vendor may disseminate such information either via regular mail (block 625) or via telephone (block 615) to accomplish this step. In the event that mail is used, a printed form with a list of available Funding Options is sent to the Customer in block 625. Upon receipt, the Customer either mails the printed form back (via regular mail or e-mail) (as represented by block 640) indicating the desired allocation or indicates their desired point allocation over the telephone by calling the Vendor (block 635).

In an instance where only the phone is used, the Customer is prompted to call the Vendor, review available Funding Options via the phone (automated or otherwise) and allocate points at the same time, as represented by blocks 615, 635.

No matter which communication method the Customer conveys their preferences for Funding Point allocation, it is likely although not required that a centralized server system would be implemented for tracking the available Funding Options and Funding Point allocation preferences. The server and software may or may not be available publicly online via the Internet.

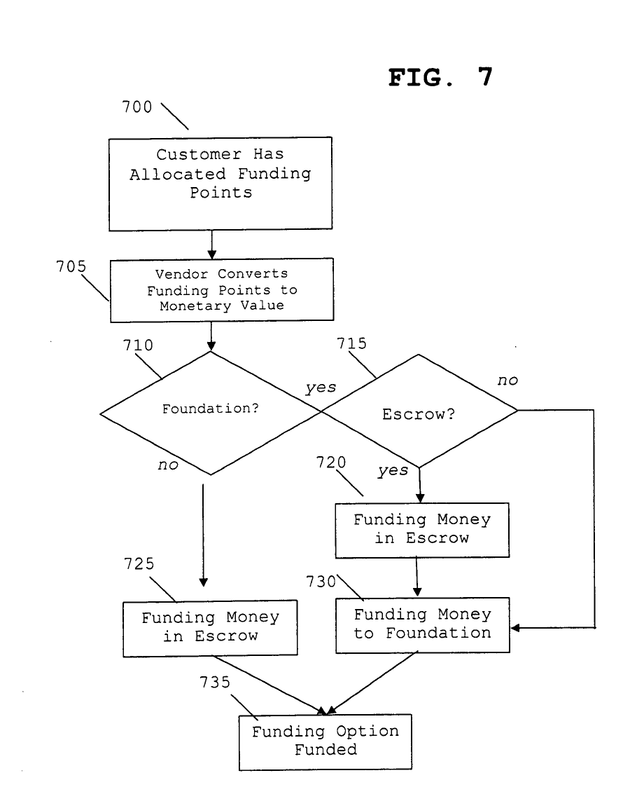

The last stage in the system and method in accordance with the present invention is distribution of funds to the selected Funding Options based on the allocation of Funding Points by the Customer. FIG. 7 is an exemplary flow chart of the funding process. Funding Points are allocated to Funding Options selected by the Customer in step 700. Thereafter, in step 705, the Vendor or centralized server converts the issued Funding Points to a monetary amount (dollar value). The actual conversion function or scheme may differ, as described in detail above with respect to point conversion in FIG. 3. The monetary amount represents the money to be funded to that particular Funding Option from the total dedicated funds that were set aside by the Vendor.

The actual funding can occur using one or more funding mechanisms: by using an escrow account to fund the project; by funding directly from the operating budget of the Vendor; by using a foundation for the actual mechanism that funds projects; or any combination thereof. Referring to FIG. 7, decision blocks 710, 715, provide the option of either establishing an escrow account or a foundation to provide the funds. In block 725 the money to be funded is provided from an escrow account. Alternatively, the money may be funded via a foundation. In such case, the funds received by the foundation may, but need not necessarily, be provided from an escrow account (see block 720). Regardless of the actual mechanism employed, the funds are transferred to the Funding Option designated by the Customer (block 735) from either the escrow account and/or foundation.

A third party audit may be conducted to provide an independent verification that reconciles user accounts to the donations actually made to the causes, projects and funding partners. The computer software in accordance with the present inventive invention is preferably programmed so as to be fully auditable by a third party.

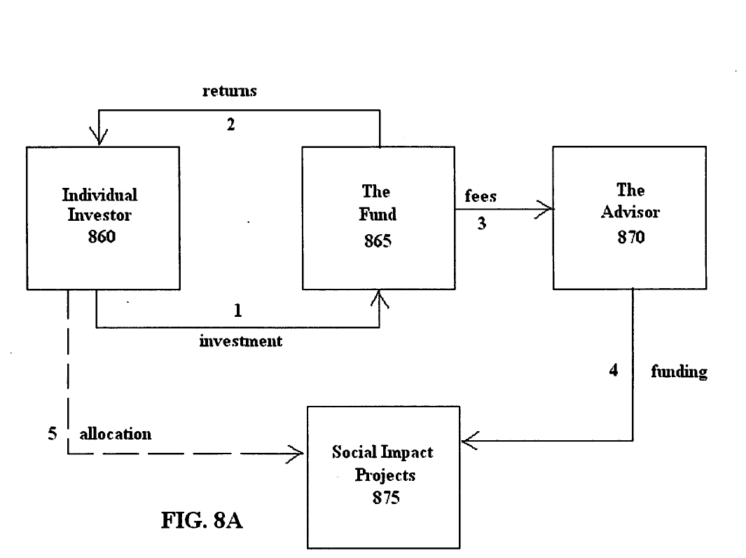

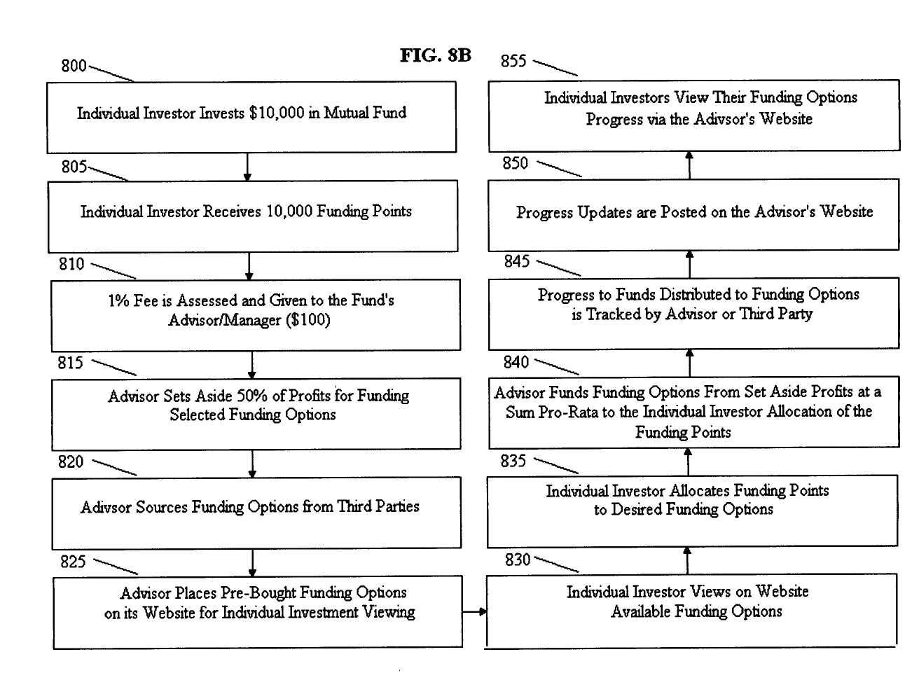

By way of illustrative example, the present invention will now be described in detail for the particular purchase of a financial investment or instrument, e.g., a mutual fund. FIG. 8A is a diagram illustrating an exemplary specific embodiment of a transfer of funds as it applies to mutual funds as a product and investment vehicle. While this embodiment is directed to the purchase of mutual funds, the present invention is suited for the purchase of other financial instruments such as 401k plans (with, or without, employer matching) or traditional Hedge Funds. Non-investment products such as credit or debit card transactions are also contemplated and within the intended scope of the present invention. An Individual Investor, Advisor (investment manager), and entity associated with a Social Impact Project are in communication via a network such as the Internet. As represented by arrow “1”, the Individual Investor (Customer) 860 invests funds in a mutual fund 865. Accrued returns on the investments 865 are returned to the Individual Investor 860, as denoted by arrow “2”, as they would with any other similar investment product. A portion of the initial amount of money placed into the mutual fund 865 is generated as a fee paid to the Advisor/Investment Manager 870, as represented by arrow “3”. A portion of the fees received by the Advisor 870 are used to fund various Projects (social and/or charitable causes) 875, as denoted by the arrow “4”. Finally, the dashed arrow “5” represents selections made by the Individual Investor 860 as to which Social Impact Projects 875 will be funded and how those funds are to be allocated among those projects. Arrow “5” is represented by a dashed lined because the actual funds flow from the Advisor 870 to the Social Impact Projects 875, rather than directly from the Individual Investor 860.

FIG. 8B is a flow chart of a specific example of the financial investment of FIG. 8A in which the Individual Investor invests $10,000 in a mutual fund (step 800). The Individual Investor receives 10,000 Funding Points, in step 805, based on their $10,000 investment. In this case the number of Funding Points is equal to the dollar value invested with the mutual fund, although as explained in detail above, alternative conversion or allocation schemes may be employed. The next step involves assessment of the fee. This step occurs as it would for any other mutual fund. A specific percentage of assets placed under management, in this case 1%, is assessed as a yearly fee. The fee is assessed by the Fund's investment Advisor or Manager. In step 810, the Advisor receives 1% of the $10,000 investment, which in the present example would be $100 in revenue. Advisor sets aside a specific amount of money for project funding, in step 815. By way of example, the Advisor sets aside 50% of the profits for project funding. The funds are placed quarterly, monthly, daily, or in any desired time frame into an escrow account from where the actual funding of projects will occur.

The Advisor sources Funding Options by establishing partnerships with non-profit entities whose principal aim is the sourcing of such projects. Funding Options may include such things as building a school in Africa, planting trees in South America, buying medication for elderly people in Eastern Europe, etc. The Funding Options may be sourced from a third party, as recognized in step 820. In the case in which the Funding Option is sourced from a third party, it may be acquired or pre-bought from the third party by the Company (see step 825). Sourced Funding Options are cultivated by the Advisor to appeal to a relatively wide audience with diverse interests in social and/or charitable causes. In step 830, the Advisor posts the sourced Funding Options online to be viewed by the Individual Investor. Each Funding Option preferably displays both the number of points required to be fully funded and the current number of accumulated Funding Points allocated to that Funding Option. There are several advantages presented by the Vendor posting the number of Funding Points needed and/or number of Funding Points already funded (or accumulated). First, such postings allow Customers to clearly see how many Funding Points are needed overall and how many remain for the Funding Option to be funded. Second, by showing that a Funding Option has already accumulated a certain number of Funding Points, this provides the Customer with a clear sense that others have contributed to the Funding Option and have found it to be worthy of their Funding Points. Third, such information allows the Customer to better allocate their Funding Points since they can maximize the immediate effect of their points by funding those options that only need their point amount to be completely funded and executed. Lastly, the information optimizes the engaging donation process since there is a clearly stated “goal” that the donors/lenders need to reach for a project to be funded. The sense of having a goal makes donors/lenders more likely to check back to see if the project has been funded and to share the project with other participating Customers to try and reach the fully funded goal. As a broad concept, information concerning the number of Funding Points need and/or number of accumulated Funding Points encourages continued engagement on the part of the Customer.

From the list of available sourced Funding Options, in step 830, 835, the 10,000 Funding Points are allocated by the Individual Investor to those Funding Options chosen to be funded. An Individual Investor may then, for example, allocate half their points to help build a school and the other half to environmental projects. In step 840, the Advisor funds the projects based on the allocated Funding Points made by all participating Individual Investors. The appropriate funds are automatically or otherwise systematically retrieved from an escrow account and paid to the appropriate Funding Option (step 845). After the Funding Option receives the funding, either the Advisor or a third party tracks its progress and reports back on its impact, updating the website with information on this progress (step 850). Finally, in step 855 the Individual Investor may view the project progress on the Advisor's website, discuss the progress with others who have allocated to it, and learn how they can be even more active in the projects or causes they funded.

Thus, the system and method in accordance with the present invention encourages communication via the Internet, or any other form of communication, among participating Customers that increases overall engagement by those Customers with particular causes or projects and forms social networks relevant to their interests. This communication typically occurs via the Vendor's website, but may be at another website. Participating Customers or others may post on the website their user profile including personal information and/or information concerning the causes and projects in which they are engaged or participate. In addition, the profile may include information concerning a past history of allocation of Funding Points. In this way, the Customer would be able to search out others who share a common interest as themselves. Once identified, these other individuals may be contacted by the Customer via e-mail, instant messaging, or other forms of communication. Furthermore, the site may encourage dialog and participation by Customers in other Funding Options.

This is only one example of the present inventive system and method in which the purchase is a mutual fund financial investment. It is self-evident that the monetary amount invested in the mutual fund may vary as desired, as well as, the fee percentage assessed the Investor and the percentage of profits set aside by the Advisor for funding the Funding Options. As previously noted, the inventive system and method may be employed using other financial investments or non-financial investments. Clearly the initial amount invested in the mutual fund and all other numerical parameters are for illustrative purposes only and in no way is intended to limit the scope of the present invention.

Thus, while there have been shown, described, and pointed out fundamental novel features of the invention as applied to a preferred embodiment thereof, it will be understood that various omissions, substitutions, and changes in the form and details of the devices illustrated, and in their operation, may be made by those skilled in the art without departing from the spirit and scope of the invention. For example, it is expressly intended that all combinations of those elements and/or steps that perform substantially the same function, in substantially the same way, to achieve the same results be within the scope of the invention. Substitutions of elements from one described embodiment to another are also fully intended and contemplated. It is also to be understood that the drawings are not necessarily drawn to scale, but that they are merely conceptual in nature. It is the intention, therefore, to be limited only as indicated by the scope of the claims appended hereto.

Every issued patent, pending patent application, publication, journal article, book or any other reference cited herein is each incorporated by reference in their entirety.

What is claimed is:

1. A method for operating a consumer-driven system for promoting philanthropic giving/lending and social activism based on a Customer purchase from a Vendor, comprising the steps of:
issuing Funding Points to the Customer based on the purchase from the Vendor;
receiving the Customer's autonomous selection of at least one Funding Option from those provided in a Funding Options Pool including one or more Funding Options;
receiving the Customer's autonomous allocation of issued Funding Points to the selected at least one Funding Option; and
funding the selected at least one Funding Option based on the Customer's allocation of issued Funding Points.

2. The method in accordance with claim 1, further comprising the step of providing the Customer feedback information concerning the funding provided to the at least one selected Funding Option to allow the Customer to evaluate its effectiveness and remain actively engaged after funding the at least one Funding Option by tracking the impact of their investment and creating a platform for initiating additional activism and involvement.

3. The method in accordance with claim 2, wherein content of the feedback information is accessible by one or more Customers that has provided funds.

4. The method in accordance with claim 2, wherein the feedback information includes at least one of a number of Funding Points needed and a number of accumulated Funding Points for the selected at least one Funding Option.

5. The method in accordance with claim 1, wherein each Funding Option is classified as either a gift or a loan, and wherein the gift or loan is on one of an organization/foundation-level, cause-level, project-level or individual-level.

6. The method in accordance with claim 1, wherein the received selection of the at least one Funding Option is on a one-time basis or an ongoing preference.

7. The method in accordance with claim 1, wherein the received allocation of issued Funding Points is on a one time basis or an ongoing preference.

8. The method in accordance with claim 1, wherein the quantity, amount and value of Funding Points are determined by the Vendor.

9. The method in accordance with claim 1, wherein the Funding Options Pool is sourced by the Vendor, from third party sources or specified by the Customer.

10. The method in accordance with claim 1, wherein the funding step comprises converting accumulated Funding Points to an equivalent monetary value to be allocated to the corresponding at least one Funding Option.

11. The method in accordance with claim 10, wherein the conversion is based on a relationship as established by the Vendor and particular to the at least one Funding Option.

12. The method in accordance with claim 1, wherein the Customer retains complete autonomy in the selection of the at least one Funding Option; the Customer designates by way of proxy their authority to a Designated Entity to select the at least one Funding Option to which the Funding Points are to be allocated on the Customer's behalf; or a default allocation scheme designed by the Vendor is applied to select the at least one Funding Option.

13. The method in accordance with claim 12, wherein the Customer designates their authority to the Designated Entity who is an individual or an entity.

14. The method in accordance with claim 13, wherein the individual is another participating Customer, an individual who is not a participating Customer, a community member or a company representative.

15. The method in accordance with claim 13, wherein the entity is a corporation, a foundation or an organization.

16. The method in accordance with claim 13, wherein information is accessible to the Customer to aide in selection of the Designated Entity including the individuals being rated by other participating Customers as to how well they know certain topics and how well they have acted in their allocation of Funding Points via proxy.

17. The method in accordance with claim 16, wherein ratings are based on at least one of the following factors: (i) overall rating issued based on a point system given by participating Customers based on their own subjective evaluation; (ii) number of Customers that have participated in the rating system; (iii) number of Funding Points allocated thus far to the individual to be rated; (iv) number of ratings issued by Customers of previously funded Funding Options; and (v) frequency of use of Funding Points by the individual that is to be rated.

18. The method in accordance with claim 13, wherein the Designated Entity selects the Funding Options, allocates the Customer's issued Funding Points based on their selection of Funding Options and tracks the progress of those funds

19. The method in accordance with claim 12, wherein the default allocation scheme is a pro-rata allocation of the Customer's Funding Points based on a total allocation of all other participating Customers Funding Points.

20. The method in accordance with claim 12, wherein the default allocation scheme mimics a particular celebrity's method for allocation.

21. The method in accordance with claim 1, further comprising the step of encouraging communication among participating Customers concerning philanthropic giving/lending and social activism.

22. A method for operating a consumer-driven system for promoting philanthropic giving/lending and social activism based on a Customer purchase from a Vendor, comprising the steps of:
issuing Funding Points to the Customer based on the purchase from the Vendor;
receiving the Customer's selection of at least one Funding Option from those provided in a Funding Options Pool including one or more Funding Options, each Funding Option being classified as either a gift or a loan, wherein the gift or loan is on one of an organization/foundation-level, project-level or individual-level;
receiving the Customer's allocation of issued Funding Points to the selected at least one Funding Option;
funding the selected at least on Funding Option based on the Customer's allocation of issued Funding Points; and
receiving feedback information concerning the funding provided to the at least one selected Funding Option.

23. A computer implemented method for operating a consumer-driven system for promoting philanthropic giving/lending and social activism based on a Customer purchase from a Vendor comprising:
issuing Funding Points to the Customer using a computer system, the Funding Points being issued are based on the purchase from the Vendor and stored in a computer memory electrically coupled to the computer system;
receiving the Customer's autonomous selection of at least one Funding Option from those provided in a Funding Options Pool including one or more Funding Options, the Customer's selection of the at least one Funding Option being stored in the computer memory;
receiving the Customer's autonomous allocation of issued Funding Points to the selected at least one Funding Option, the Customer's allocation of issued Funding Points being stored in the computer memory; and
funding the selected at least one Funding Option based on the Customer's allocation of issued Funding Points retrieved from the computer memory.

24. A computer program embodied on a computer-readable medium for operating a consumer-driven system for promoting philanthropic giving/lending and social activism based on a Customer purchase from a Vendor comprising: (a) a code segment that issues Funding Points to the Customer, the Funding Points being issued are based on the purchase from the Vendor; (b) a code segment that receives the Customer's autonomous selection of at least one Funding Option from those provided in a Funding Options Pool including one or more Funding Options; (c) a code segment that receives the Customer's autonomous allocation of issued Funding Points to the selected at least one Funding Option; and (d) a code segment that funds the selected at least one Funding Option based on the Customer's allocation of issued Funding Points.

25. The computer program in accordance with claim 24, further comprising a code segment for auditing by a third party.
